(19) United States
(12) Patent Application Publication
(10) Pub. No.: US 2026/0211168 A1
(43) Pub. Date: Jul. 23, 2026

(54) INTEGRATING WAVEFRONT CORRECTION WITHIN OPTICAL SYSTEMS

(71) Applicant: Analog Photonics LLC, Boston, MA (US)

(72) Inventors: Jingda Wu, Everett, MA (US); Michael J. Nickerson, Boston, MA (US); Michael Robert Watts, Hingham, MA (US)

(73) Assignee: Analog Photonics LLC, Boston, MA (US)

(21) Appl. No.: 19/448,926

(22) Filed: Jan. 14, 2026

Related U.S. Application Data
(60) Provisional application No. 63/746,369, filed on Jan. 17, 2025.

(51) Int. Cl. G02B 5/30; G02B 27/00

(52) U.S. Cl. CPC G02B 5/3083; G02B 27/0025

(57) ABSTRACT

Forming a wavefront corrected optical system includes: forming a phase adjusting layer onto a portion of an optical aperture of an optical device, the forming comprising: forming a first material that is at least partially optically transparent onto the portion of the optical aperture, determining at least one wavefront characteristic of an optical wave emitted from the optical aperture, and modifying a phase shifting pattern over a first volume of the first material based at least in part on the at least one wavefront characteristic; and forming an index-mismatched layer onto at least a portion of the phase adjusting layer. A refractive index of the index-mismatched layer is different from a refractive index of the first material. A first surface of the index-mismatched layer conforms to a surface of the phase adjusting layer. A second surface of the index-mismatched layer preserves a phase correction associated with the phase adjusting layer.

### CROSS-REFERENCE TO RELATED APPLICATION(S)

This application claims the benefit of and priority to U.S. Provisional Application Ser. No. 63/746,369, entitled “INTEGRATING WAVEFRONT CORRECTION WITHIN OPTICAL SYSTEMS,” filed Jan. 17, 2025, which is incorporated herein by reference.

### TECHNICAL FIELD

This disclosure relates to integrating wavefront correction within optical systems.

### BACKGROUND

In diffractive or refractive optical systems, wavefront errors are often introduced due to manufacturing and fabrication imperfections, which can significantly degrade system performance. For example, in optical phased arrays (OPAs)—where the phases of individual antennas are controlled for beam steering, sometimes used in light detection and ranging (LiDAR)-phase distortions can arise from fabrication issues such as wafer bowing, material thickness variation, and structural size inconsistencies. These distortions can result in beam divergence and misalignment, which can severely compromise system performance and may render the technology unsuitable for many applications. Similarly, flat optical elements like metalenses can be highly susceptible to wavefront errors caused by fabrication variations, especially given the sub-micrometer feature sizes associated with their operation. While design strategies can mitigate some errors, manufacturing imperfections may be unavoidable and become increasingly challenging to control as feature sizes decrease. The optical waves used in such systems can have a peak wavelength that falls in a particular range (e.g., between about 100 nm to about 1 mm, or some subrange thereof), also referred to herein as simply “light.”

### SUMMARY

In one aspect, in general, a method for forming a wavefront corrected optical system comprises: forming a phase adjusting layer onto a portion of an optical aperture of an optical device, the forming comprising: forming a first material that is at least partially optically transparent onto the portion of the optical aperture, determining at least one wavefront characteristic of an optical wave emitted from the optical aperture, and modifying a phase shifting pattern over a first volume of the first material based at least in part on the at least one wavefront characteristic; and forming an index-mismatched layer onto at least a portion of the phase adjusting layer, wherein: a refractive index of the index-mismatched layer is different from a refractive index of the first material, a first surface of the index-mismatched layer conforms to a surface of the phase adjusting layer, and a second surface of the index-mismatched layer is configured to preserve a phase correction associated with the phase adjusting layer.

Aspects can include one or more of the following features.

The second surface of the index-mismatched layer is configured to preserve a phase correction associated with the phase adjusting layer by being substantially flat over a first area intersecting an optical propagation path from the optical aperture and through the first volume.

The second surface of the index-mismatched layer is configured to preserve a phase correction associated with the phase adjusting layer by conforming to a surface of an optical element having a refractive index that is substantially identical to the refractive index of the index-mismatched layer.

The modifying the phase shifting pattern over the first volume of the first material comprises removing at least a portion of the first material from at least a portion of the first volume.

The removing is performed by hardening a first portion of the first material by absorption of optical power and removing a second portion of the first material that has not been hardened to form a pattern of different thicknesses of the first material over the first volume.

The modifying the phase shifting pattern over the first volume of the first material comprises adding more of the first material over at least a portion of the first volume.

The adding more of the first material comprises depositing multiple sublayers of the first material in different locations to form a pattern of different thicknesses of the first material over the first volume.

The adding further comprises hardening portions of the multiple sublayers of the first material by absorption of optical power.

The optical device comprises a photonic integrated circuit, a device comprising photonics metastructures, an optoelectronic device, or a surface emitting laser.

The optical aperture comprises a surface from which a plurality of optical waves is emitted from respective optical antennas formed in proximity to the surface.

The phase adjusting layer is formed after assembling the photonic integrated circuit onto a portion of an optical system.

The photonic integrated circuit is formed on a silicon-on-insulator die.

The forming further comprises, for each iteration of a plurality of iterations, determining at least one wavefront characteristic of an optical wave emitted from the optical aperture, and modifying a phase shifting pattern over a portion of the first volume of the first material based at least in part on the at least one wavefront characteristic.

In another aspect, in general, an apparatus comprises: an optical device comprising an optical aperture configured to transmit and/or receive one or more optical waves; a phase adjusting layer formed on a portion of the optical aperture, wherein the phase adjusting layer: is formed from a first material that is at least partially optically transparent, and provides a phase shifting pattern over a first volume of the first material based at least in part on at least one wavefront characteristic of an optical wave emitted from the optical aperture determined before the phase adjusting layer was modified to provide the phase shifting pattern; and an index-mismatched layer formed on at least a portion of the phase adjusting layer, wherein: a refractive index of the index-mismatched layer is different from a refractive index of the first material, a first surface of the index-mismatched layer conforms to a surface of the phase adjusting layer, and a second surface of the index-mismatched layer is configured to preserve a phase correction associated with the phase adjusting layer.

Aspects can include one or more of the following features.

The second surface of the index-mismatched layer is configured to preserve a phase correction associated with the phase adjusting layer by being substantially flat over a first area intersecting an optical propagation path from the optical aperture and through the first volume.

The second surface of the index-mismatched layer is tilted such that the second surface is not parallel to a surface of the optical aperture.

The second surface of the index-mismatched layer is configured to preserve a phase correction associated with the phase adjusting layer by conforming to a first surface of an optical element having a refractive index that is substantially identical to the refractive index of the index-mismatched layer.

The first surface of the optical element is bonded to the second surface of the index-mismatched layer.

A second surface of the optical element has a coating comprising one or more layers formed on the second surface of the optical element, where the coating is configured to reduce reflections of the second surface of the optical element.

The optical device comprises a photonic integrated circuit, a device comprising photonics metastructures, an optoelectronic device, or a surface emitting laser.

Aspects can have one or more of the following advantages.

Some of the techniques described herein enable wavefront correction directly on light emitting and/or receiving portions of optical systems, for example, portions of optical chips or optical devices formed from chips. The wavefront correction can address fabrication errors, enhance optical performance, and/or simplify manufacturing. There are different techniques that can be used to correct the wavefront error in optical systems. In some implementations, the techniques include structuring an optical phase adjusting layer directly on a portion of an optical system (e.g., an optical system on a photonic integrated circuit) that contains optics or optical antennas through which one or more optical beams are transmitted using techniques such as laser structuring, multi-photon lithography, and/or additive manufacturing to improve the performance of these systems.

Improving fabrication processes to reduce such errors can be both costly and time-consuming. As a result, post-fabrication wavefront correction may be useful. One possible approach is the use of active adaptive optics, such as liquid crystal spatial phase modulators or deformable mirrors. However, these solutions may be bulky, expensive to produce, and prone to optical losses. Liquid crystal phase modulators, for instance, may introduce polarization scrambling, further diminishing the system's efficiency.

Alternatively, pre-fabricated phase plates can correct wavefront errors. While simpler and more cost-effective than adaptive optics, such phase plates may be bulky to ensure mechanical strength and fabrication feasibility. This bulkiness potentially can exacerbate wavefront errors at oblique beam angles, deviating from their design specifications. Packaging such systems may also be a significant challenge, and may introduce additional errors that further degrade system performance. The packaging process can also be time-consuming, which increases manufacturing cost.

Instead of such techniques, the techniques described herein enable a phase adjusting layer to be formed directly on a portion of a chip that has an optical aperture. To relax the tolerances of the wavefront correction that is provided, making the overall wavefront correction more robust, the techniques also include an index-mismatched layer formed on the phase adjusting layer in a manner that preserves the wavefront correction, as described in more detail below.

The wavefront correction techniques can be used with light detection and ranging (LiDAR) systems that incorporate optical phased arrays (OPAs) or other optical structures to transmit and/or receive light through an optical aperture. Some LiDAR systems optimize various aspects of the LiDAR configuration based on different criteria. An optical wave is transmitted from an optical source to target object(s) at a given distance and the light backscattered from the target object(s) is collected. Some OPAs used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. The wavefront correction techniques can aid in forming high quality beams used by such LiDAR systems that are free of wavefront aberrations.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1C are schematic diagrams of cross-sectional views of portions of example devices.

FIGS. 2A-2E are schematic diagrams of cross-sectional views of portions of an example device during processing stages of an example process for in situ optical phase adjusting layer laser structuring.

FIG. 3 is a schematic diagram of a cross-sectional view of a portion of an example device depicting an example of the conformity of an optical phase adjusting layer.

FIG. 4 is a schematic diagram of a cross-sectional view of a portion of an example device during a processing stage comprising two-photon lithography.

FIG. 5 is a schematic diagram of a cross-sectional view of a portion of an example device comprising a curved optical device.

FIGS. 6A-6D are schematic diagrams of cross-sectional views of portions of example devices.

FIG. 7 is a schematic diagram of an example of a LiDAR system.

FIG. 8A is a schematic diagram of an example of an optical phased array.

FIG. 8B is a schematic diagram of an example of an optical switched array.

FIG. 9 is a schematic diagram of an example of a grating-antenna-based optical phased array.

FIG. 10 is a schematic diagram of an example of angular steering associated with radiation intensity patterns for optical phased arrays.

FIG. 11 is a flowchart of an example technique.

### DETAILED DESCRIPTION

The techniques described herein enable accurate wavefront error correction by directly processing materials on a portion of an optical system to create a conformal phase adjusting layer. This approach is applicable regardless of the substrate shape.

In some implementations, an optical device can be configured to generate, manipulate, and/or detect optical waves. An optical device can be implemented as a circuit architecture comprising optical circuits integrated on one or more chips or devices. In some examples, an optical device can be implemented in various configurations, including as a single apparatus or as a combination of one or more apparatuses that collectively perform the functions of a system. Some optical devices comprise photonic integrated circuits (PICs) that combine a plurality of optical components, where each optical component is configured to perform a function. In some implementations, components of an optical device can be interconnected by structures that are configured to guide optical waves, sometimes referred to as optical waveguiding structures or optical waveguides.

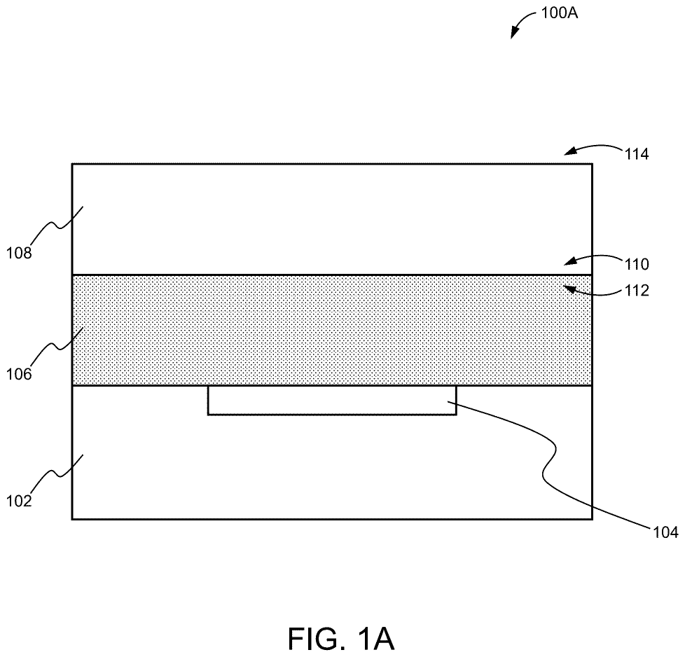

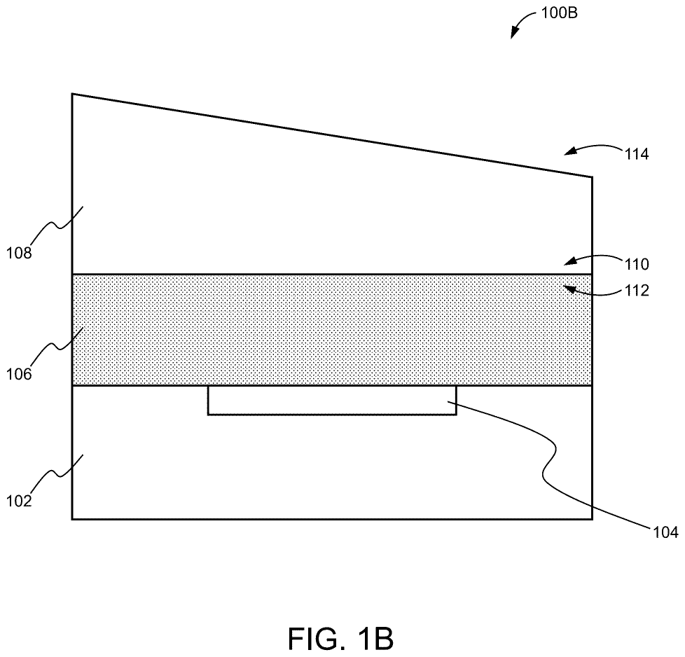

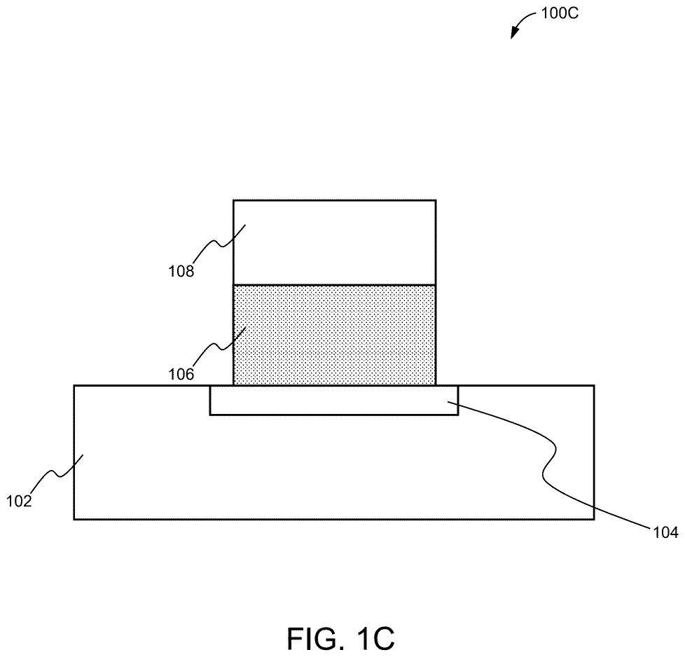

FIG. 1A depicts a cross-sectional view of a portion 100A of an example device. The portion 100A comprises an optical device 102. The optical device 102 comprises an optical aperture 104. A phase adjusting layer 106 is formed over at least a portion of the optical aperture 104. In this example, the phase adjusting layer 106 is formed over the optical aperture 104, as well as portions of the optical device 102 around the optical aperture 104. As described later and depicted in FIG. 1C, some implementations can form a phase adjusting layer onto just a portion of the optical aperture.

The phase adjusting layer 106 is formed from a first material that is at least partially optically transparent. The phase adjusting layer 106 is configured to provide a phase shifting pattern over a first volume of the first material based at least in part on at least one wavefront characteristic of an optical wave emitted from the optical aperture 104. A wavefront of a field of optical waves can refer to a set of points having the same optical phase. In some examples, a wavefront can depend on properties of a material through which an optical wave is propagating. The phase shifting pattern of the phase adjusting layer 106 can adjust or shape a wavefront of an optical wave emitted by the optical aperture 104. A phase shifting pattern of a layer can depend on characteristics of the layer such as geometric dimensions, surface roughness, and refractive index. As described later, the phase adjusting layer 106 can provide the phase shifting pattern based on the at least one wavefront characteristic determined before the phase adjusting layer was modified to provide the phase shifting pattern. In some implementations, including a phase adjusting layer can for correction and/or compensation of fabrication errors or device geometries.

By way of example, a phase adjusting layer 106 can be configured to provide a phase shifting pattern such that a wavefront of an optical wave emitted by the device can be substantially flat. Such implementations can be useful in using the device to transmit or receive optical waves.

Optical waves propagating in media can propagate according to a speed or velocity. In some examples, this speed can result in optical waves acquiring a phase based at least in part an optical wavelength of the optical wave. Optical waves propagating between different media can experience refraction, or redirection of the optical waves as the optical waves propagate from one medium to another medium. A metric to quantify a refraction of a medium is the refractive index, which is the ratio of the speed of light in a medium relative to the speed of light in vacuum. In some implementations, a device can be configured based on refractive indices of materials of the device, as well as media surrounding a device. For instance, the optical device 102 can be formed on a silicon-on-insulator die and can be operated with air surrounding the device. The difference in refractive index between the optical device 102 and air can result in refraction of optical waves transmitted from or received by the optical aperture 104, which can be associated with optical losses. Configuring layers of a device to compensate for this refractive index difference can allow for optical losses to be reduced.

By way of example, the portion 100A further comprises an index-mismatched layer 108 that is formed onto at least a portion of the phase adjusting layer 106. The refractive index of a material of the index-mismatched layer 108 is different from a refractive index of the first material of the phase adjusting layer 106. A first surface 110 of the index-mismatched layer 108 conforms to a surface 112 of the phase adjusting layer 106. A second surface 114 of the index-mismatched layer 108 is configured to preserve a phase correction associated with the phase adjusting layer 106. In this example, the second surface 114 is configured to preserve the phase correction by being substantially flat over a first area intersecting an optical propagation path from the optical aperture 104 and through the first volume of the phase adjusting layer 106.

As shown in FIG. 1A, the index-mismatched layer 108 is an intermediate layer between the phase adjusting layer 106 and a medium surrounding the portion 100A and a gradient step between a refractive index of the phase adjusting layer 106 and the medium. Such implementations can allow for the formation of phase adjusting layers with geometric properties or characteristics that might otherwise affect optical waves. For instance, a surface roughness or variation in height of a phase adjusting layer can affect a wavefront of an optical wave. By including an index-mismatched layer, the impact of these factors on the wavefront of an optical wave can be reduced. In addition, as described later, an index-mismatched layer can facilitate the inclusion of other layers to a device to allow for a gradient of refractive indices. Such implementations can reduce optical losses.

In some examples, a device can be configured to provide or receive optical waves having a wavefront that is tilted or nonparallel relative to the optical aperture. In some examples, an index-mismatched layer can be configured such that the second surface of the index-mismatched material is not parallel to a surface of the optical aperture. FIG. 1B depicts a cross-sectional view of a portion 100B of an example device wherein the second surface 114 of the index-mismatched layer 108 is not parallel to a surface of the optical aperture 104.

Some implementations can form a phase adjusting layer onto just a portion of the optical aperture 104. FIG. 1C depicts a cross-sectional view of a portion 100C of an example device wherein the phase adjusting layer 106 is formed onto a portion of the optical aperture 104.

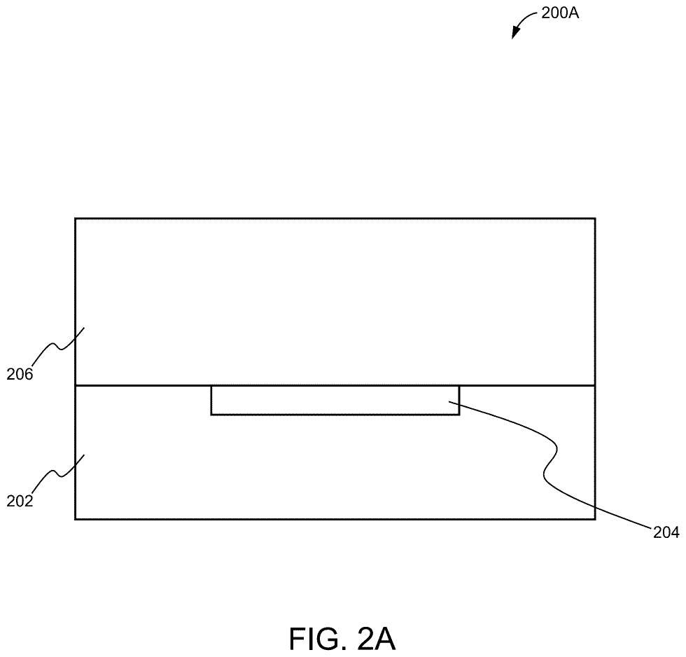

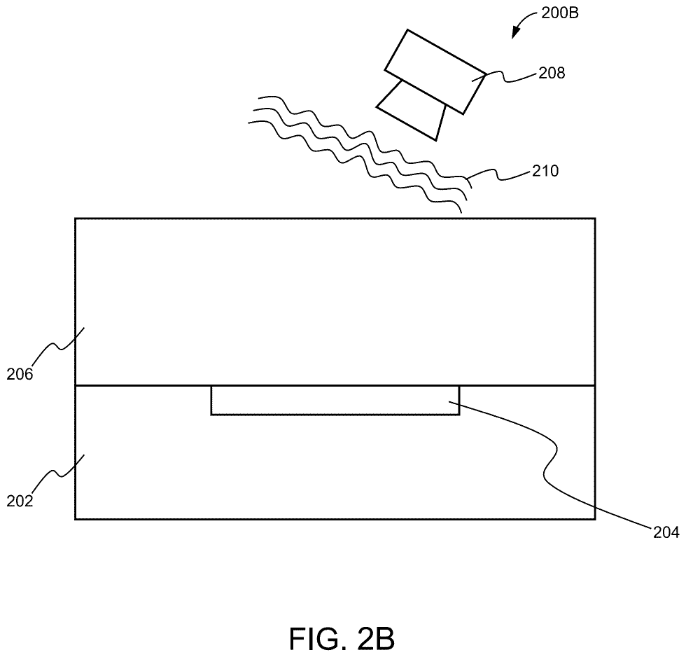

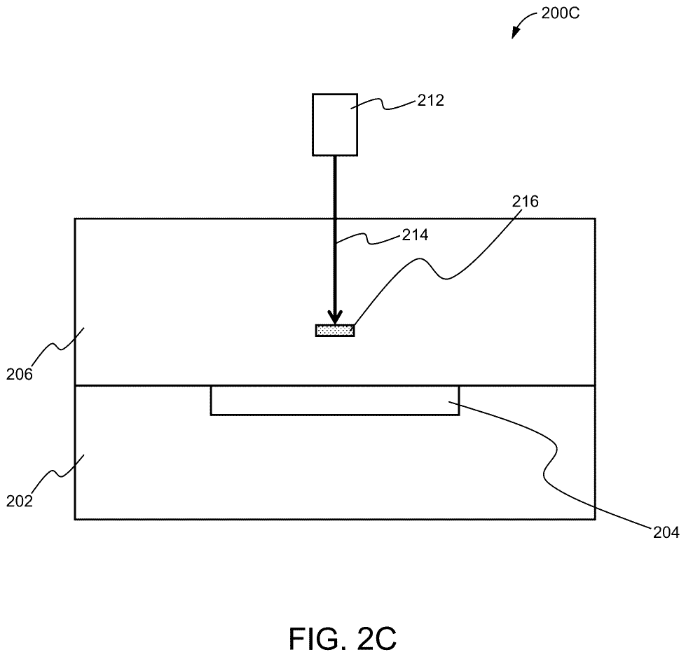

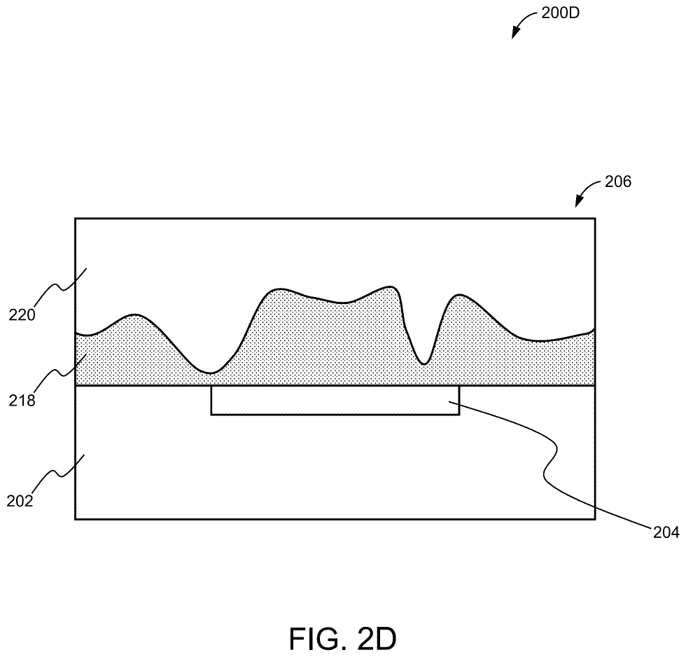

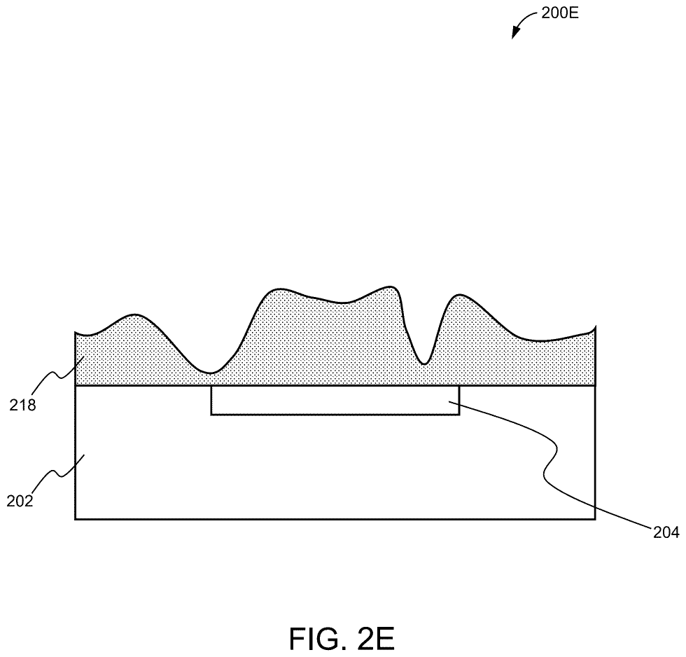

FIGS. 2A-2E depict example cross-sectional views of a portion of a device during processing steps 200A-200E of in situ phase adjusting layer laser structuring for correcting wavefront errors on an optical device. The processing steps 200D-200E can be part of a process to form the portion 100A, the portion 100B, or the portion 100C.

FIG. 2A depicts an example cross-sectional view of a portion of a device during a processing step 200A in which a layer 206 is deposited onto a portion of an optical aperture 204 of an optical device 202 for phase correction. Subsequent processing steps can be used to form a phase adjusting layer from the layer 206. In other words, the process comprises forming a phase adjusting layer on a portion of an optical aperture of the optical device. In this example, the layer 206 is formed over the optical aperture 204, as well as portions of the optical device 202 around the optical aperture 204.

Some phase adjusting layers can comprise materials that are at least partially optically transparent. Some optically transparent materials, such as ultra-violet (UV) epoxy or index-matching epoxy, can be deposited and subsequently cured on the optical system, or components thereof, to be corrected. For instance, components can include optical phased arrays or photonic metastructures. Sometimes the cladding material, such as oxide, on the chip itself can serve as the transparent material for phase plate structuring. The transparent materials, for example, can have a transmittivity for at least some optical wavelengths that is relatively large, e.g., at least 50%, or in some cases at least 90%, or at least 99%, depending on the loss tolerances in the optical system. A high-resolution laser engraving system-similar to the Laser-Assisted In Situ Keratomileusis (LASIK) systems that use an excimer UV laser for vision correction-can be employed to structure the deposited materials into a phase adjusting layer.

With any technique for structuring a transparent material, the phase adjusting layer's size and the degree of wavefront correction can be precisely tailored using wavefront measurements. For high-precision applications, iterative measurement and correction cycles can be used to increase accuracy. Phase adjusting layers that have phase adjusting patterns in two dimensions or in three dimensions can be fabricated using these techniques.

In some implementations, the layer 206 can be formed using deposition methods such as spin-coating, spray-coating or knife coating such that a thin and uniform film is produced. Strict uniformity is unnecessary due to subsequent wavefront error measurement, as shown in FIG. 2B and described later.

In some implementations, the layer 206 can comprise a material such as an index-matching epoxy. Such implementations can involve curing or hardening the index-matching epoxy of the layer 206 to solidify the index-matching epoxy for subsequent fabrication steps. In some implementations, as described and demonstrated later, optical sources such as a laser can be used to selectively cure or harden portions of a material.

As an alternative to index-matching epoxy, other optical polymers or inorganic transparent materials compatible with laser structuring can be used. At this stage, the optical device may be ready to undergo optical assembly for integration into an active system. In specific cases, the index-matching epoxy layer can be pre-treated through processes such as laser cutting to expose regions that are used for wire bonding, complementary metal-oxide-semiconductor (CMOS) integration, or fiber attachment.

Some optical devices, such as the optical device 202, can be formed from an optical chip. In some implementations, an optical device can comprise a photonic integrated circuit, a device comprising photonics metastructures, an optoelectronic device, or a surface emitting laser.

Some photonic metastructures comprise nanoscale or sub-wavelength structures that can manipulate optical properties of an optical wave interacting with the photonic metastructure. For instance, a photonic metastructure can manipulate optical properties such as phase, polarization, or amplitude. Some photonic metastructures can be configured to focus, expand, collimate, or change a direction of propagation associated with an optical wave. An example of a photonic metastructure is a metasurface. Another example of a photonic metastructure is a metalens.

Some optoelectronic devices can be configured to convert between electrical energy and optical energy. Examples of optoelectronic devices include light-emitting diodes (LEDs), laser diodes, and photodiodes.

In some implementations, a photonic integrated circuit or an optical device can be formed from a silicon-on-insulator die, or another material that is compatible with optical wavelengths.

FIG. 2B depicts an example cross-sectional view of a portion of a device during a processing step 200B in which at least one wavefront characteristic associated with the optical device 202 is determined. In other words, a processing step can comprise determining at least one wavefront characteristic associated with the optical device 202. In some implementations, determining at least one wavefront characteristic can comprise measuring a wavefront error from an optical wave emitted by the optical aperture 204 of the optical device 202. In this example, a wavefront sensor 208 is used to measure an optical wave 210. Determining the wavefront error can be used to guide the design of a phase adjusting layer. The measurement can account for wavefront changes introduced by the phase adjusting layer, or a material thereof, significantly enhancing correction accuracy. Alternatively, wavefront information can be derived from calculations based on the far-field pattern emitted by the optical system. In some implementations, wavefront characteristics of an optical wave that would be emitted without the phase adjusting layer can be inferred from other measurements performed on the index-matching epoxy, or other material used for the phase adjusting layer.

FIG. 2C depicts an example cross-sectional view of a portion of a device during a processing step 200C comprising modifying a phase shifting pattern of the layer 206. In this example, a laser structuring system 212 is employed to shape or modify the layer 206 over a first volume of a material of the layer 206 for wavefront correction. The laser structuring system 212 is configured to emit an optical wave 214. High-resolution, clean surface structuring can be achievable with an excimer laser system, although other laser systems may be chosen depending on the specific application.

In some implementations, a laser structuring system can be configured to harden a first portion of a material of the layer 206 by absorption of optical power by the material. By way of example, the laser structuring system 212 of FIG. 2C hardens a portion 216 of the layer 206.

FIG. 2D depicts an example cross-sectional view of a portion of a device during a processing step 200D following laser structuring. As shown in this example, the layer 206 comprises a first portion 218 of material that has been hardened and a second portion 220 of material that has not been hardened. The second portion 220 of material that has not been hardened can then be removed to form a pattern of different thicknesses of the material over a volume.

FIG. 2E depicts an example cross-sectional view of a portion of a device during a processing step 200E following removal of the second portion 220. The first portion 218 that remains forms a phase adjusting layer. As shown in FIG. 2E, the material of the phase adjusting layer, i.e., the first portion 218, comprises a pattern of different thicknesses of the material over a volume. The shapes of the layers illustrated in FIGS. 2D-2E are merely an example for illustrative purposes, not necessarily the case for real world applications.

In some examples, a device can be cleaned or rid of debris following laser ablation.

In some examples, the processing steps associated with FIGS. 2B and 2C can be executed iteratively to get improved results. In other words, for each iteration of a plurality of iterations, a procedure can comprise determining at least one wavefront characteristic of an optical wave emitted by the optical aperture and modifying a phase shifting pattern over a volume of a material of a phase adjusting layer based at least in part on the at least one wavefront characteristic.

Some optical chips can be warped during the assembly process due to uneven strains or pressures. While the resulting surface non-uniformity is typically below one wavelength—on the micrometer scale—such deviations can still severely impact optical system performance. With the direct deposition of the phase adjusting layer material onto the optical substrate, laser structuring can correct wavefront errors while ensuring the phase adjusting layer remains conformal to the chip.

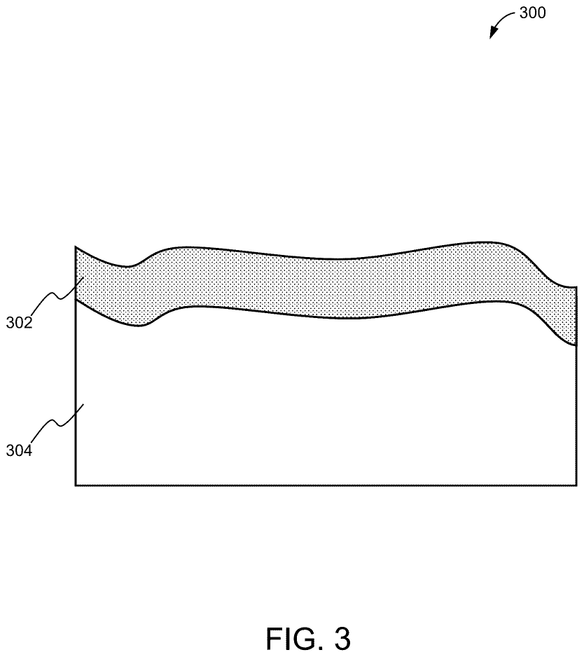

In some implementations, a phase adjusting layer can conform to a shape of a substrate regardless of the shape of the substrate. FIG. 3 depicts a cross-sectional view of a portion 300 of a device. As shown in FIG. 3, the portion 300 comprises a phase adjusting layer 302 formed onto a portion of an optical device 304. In this example, a surface of the optical device 304, i.e., the top surface, is uneven. A surface of the phase adjusting layer 302 that is in contact with the surface of the optical device 304 conforms to the surface of the optical device 304.

Some materials can harden or cure upon absorption of optical waves having certain optical powers and optical wavelengths. An optical wavelength can be inversely proportional to an optical frequency or an optical energy of an optical wave. For instance, UV epoxy can be cured by absorbing optical waves in the UV region of the electromagnetic spectrum. In some examples, a material can harden or cure upon absorption multiple photons having lower energies that sum to a higher energy. For instance, a material such as a UV epoxy can be cured or hardened by absorption of two photons in the IR region of the electromagnetic spectrum. In some implementations, forming structures using a two-photon system rather than a one-photon system can be associated with a higher feature resolution.

In other words, some implementations can utilize a two-photon lithography system to write the phase adjusting layer directly onto the optical system. This technique relies on applying a transparent polymer and using two-photon absorption occurring only at points of highest optical intensity, cross-linking the polymer to form the desired phase adjusting layer structure. Other techniques can be used to etch away or remove portions of the transparent material.

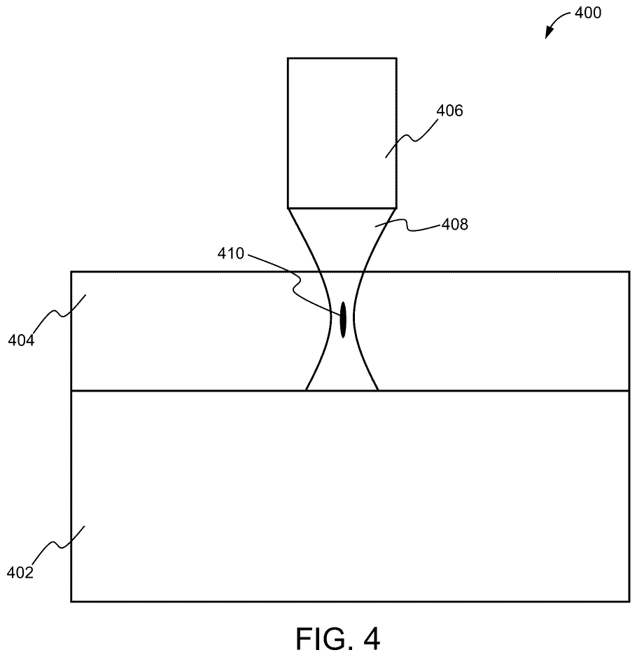

FIG. 4 depicts a cross-sectional view of a portion 400 of a device during an example processing step comprising the use of two-photon lithography for phase adjusting layer fabrication. The portion 400 comprises an optical device 402 and a phase adjusting layer 404. The phase adjusting layer 404 comprises a material such as a polymer. In this approach, the laser structuring system described in the processing step shown in FIG. 2C is replaced with a two-photon lithography system 406. An optical beam 408, sometimes referred to as a laser beam, is tightly focused onto the material of the phase adjusting layer 404, cross-linking the material only at the desired locations, allowing for the direct writing of a phase adjusting layer having three-dimensional (3D) features. By way of example, a focus 410 of the optical beam 408 is shown in FIG. 4. The optical power at the focus 410 can induce cross-linking of the material in a small region around or within the focus 410. Uncross-linked material residues can be washed away or removed after the writing process, leaving the structured phase adjusting layer. In other words, a processing step can comprise hardening a first portion of a material of a phase adjusting layer by absorption of optical power and removing a second portion of the material of a phase adjusting layer that has not been hardened to form a pattern of different thicknesses. In some implementations, this method can achieve vertical resolutions as fine as 100 nm, enabling the fabrication of highly accurate phase adjusting layers.

In some implementations, additive manufacturing methods can be used for fabricating the phase adjusting layer. High resolution fabrication can be achieved by using layer-by-layer deposition of polymers and structuring with UV exposures to cross-link the polymers, which makes the polymer harder in the exposed locations. Other techniques can be used to add portions of the transparent material.

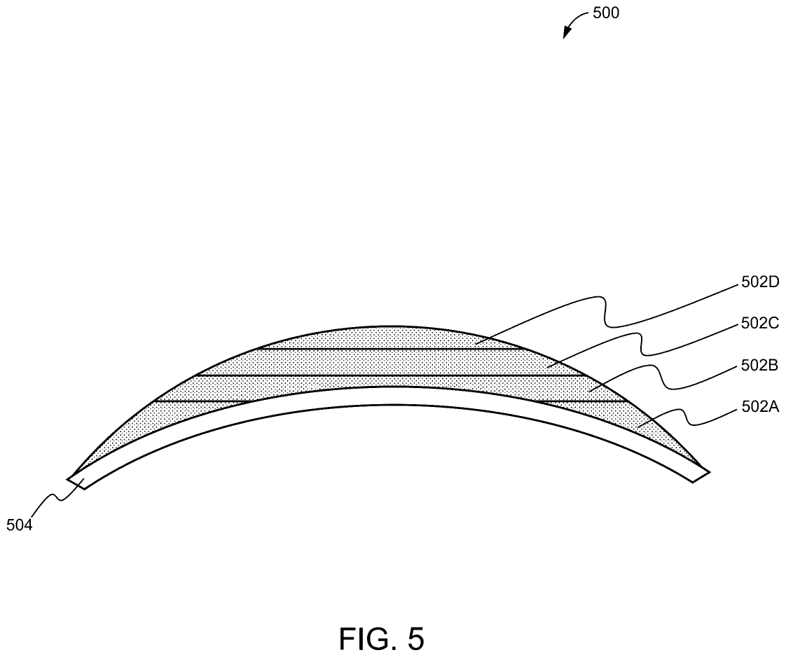

FIG. 5 depicts an example portion 500 of a device comprising a phase adjusting layer comprising a plurality of sublayers 502A-502D of material formed on an optical device 504. The plurality of sublayers 502A-502D comprises a sublayer 502A, a sublayer 502B, a sublayer 502C, and a sublayer 502D of material. In this approach, the processing step in FIG. 2C can be replaced with additive manufacturing of sublayers to build up the phase adjusting layer. A material of the phase adjusting layer such as a polymer can be deposited sublayer by sublayer and cross-linked to form a structure by exposing to light, similar to resin additive manufacturing. In some examples, UV light can be used to form the structure. In other words, multiple sublayers of a material can be deposited in different locations to form a pattern of different thicknesses of a material over a volume. Other additive manufacturing methods such as direct deposition of polymers with jets can also be used in this approach.

For scenarios where achieving sufficient vertical resolution is challenging—due to constraints like laser power, numerical aperture, or material properties—an additional index-mismatched layer can be employed to provide contrast in the refractive index (or simply “index”) of the materials, also referred to as “index contrast.” For instance, when correcting surface-emitting optical phased arrays with oxide cladding, an epoxy layer with a refractive index of 1.45 can be laser-structured to provide the phase adjusting layer, and a second layer of index-matching fluid with an index of 1.445 such that it is index mismatched with the epoxy layer, also referred to as an index-mismatched layer, can be deposited on top of at least a portion of the phase adjusting layer. In some examples, this layer can be deposited by a process such as spin coating. This 0.005 index contrast relaxes the manufacturing precision requirements while maintaining effective wavefront correction. The refractive index of the index-mismatched layer can also be larger than the refractive index of the phase adjusting layer in some implementations. Other refractive index differences can be used (e.g., within 0.01, within 0.05, or within 0.1) to suit specific applications. A small index contrast can also be chosen to reduce the optical loss due to the index contrast. In applications where optical loss is not a concern, or the loss can be controlled through methods of anti-reflection (AR) coating, a larger index contrast (e.g., index differences of 0.2, 0.5, or even larger than 1) can be used, especially for interfaces with large natural index differences, such as between indium gallium arsenide (InGaAs) and air/vacuum. Index contrast can be quantified in any of a variety of ways. In addition to a simple difference between the layer indices n₁−n₂ (where n₁>n₂), any of the following measures of index contrast can be used:

$$\frac{{n}_{1} - {n}_{2}}{{n}_{1}} , \frac{{n}_{1}^{2} - {n}_{2}^{2}}{2 {n}_{1}^{2}} , or \sqrt{{n}_{1}^{2} - {n}_{2}^{2}} ,$$

where the range of index contrast values to be used depends on the measure selected.

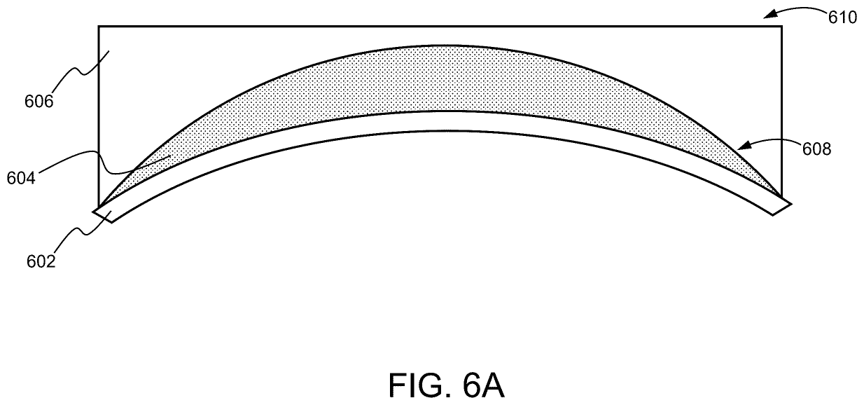

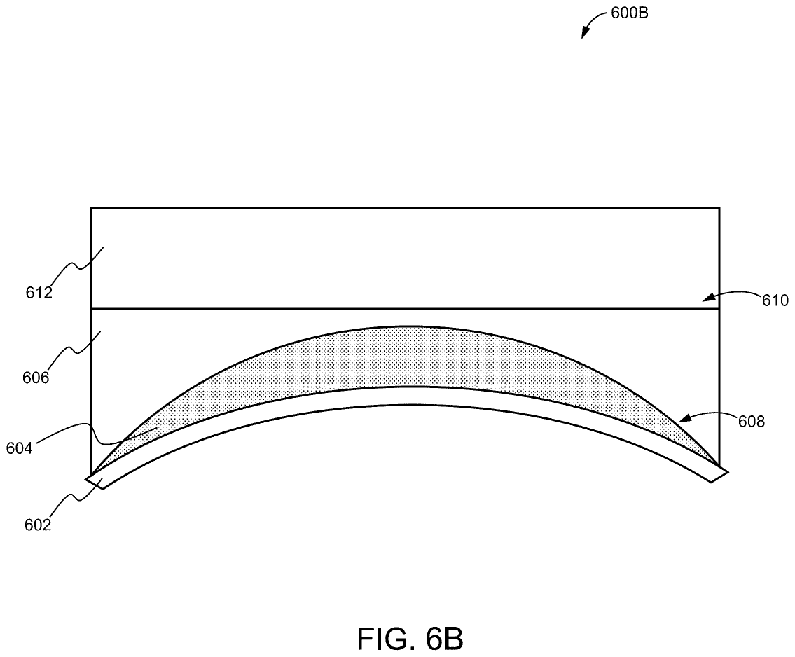

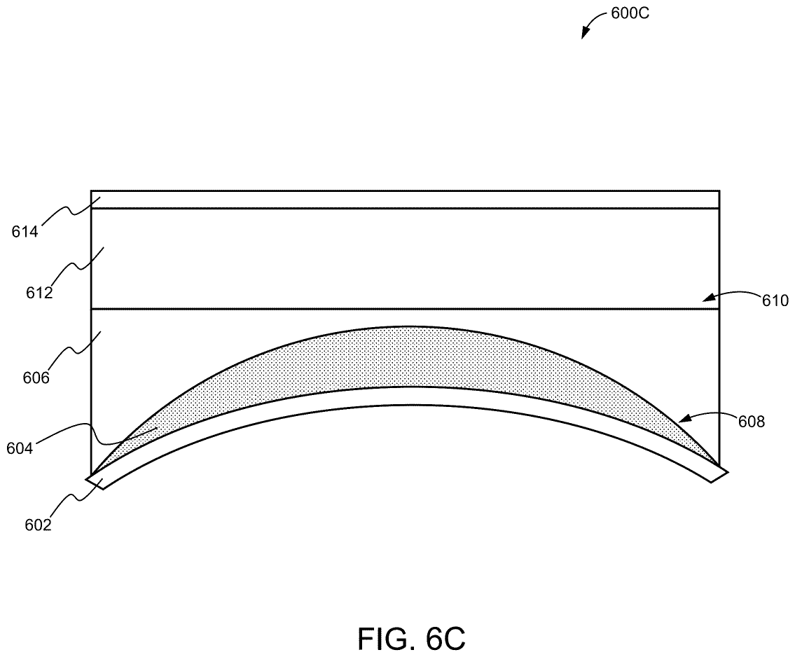

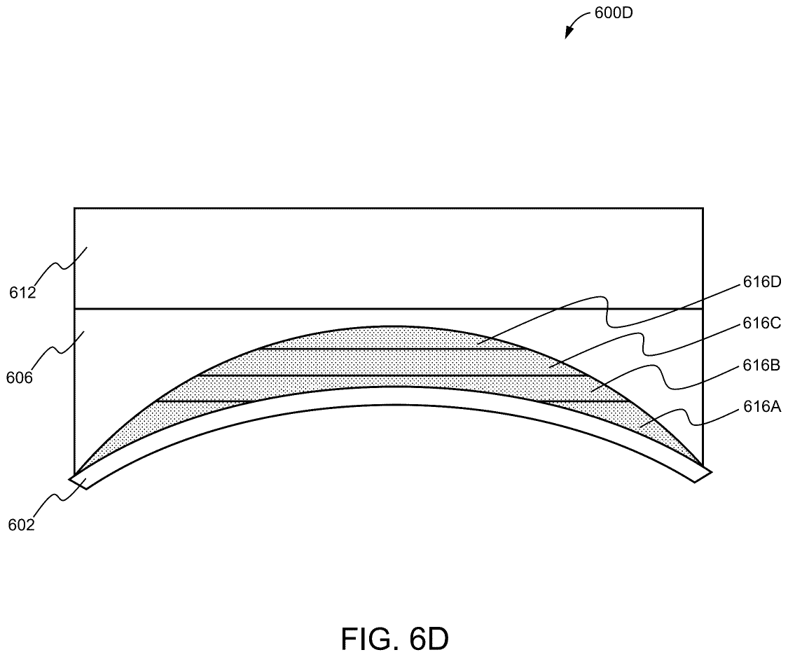

FIG. 6A depicts a cross-sectional view of an example portion 600A of a device. The portion 600A comprises an optical device 602 that is warped. In this example, a surface of the optical device 602 is curved. The portion 600A further comprises a phase adjusting layer 604. As previously described, the phase adjusting layer 604 can be structured by a laser such that the phase adjusting layer 604 can be referred to as a laser-structured phase adjusting layer. The portion 600A further comprises an index-mismatched layer 606. As shown in FIG. 6A, a first surface 608 of the index-mismatched layer 606 conforms to a surface of the phase adjusting layer 604.

A refractive index of a material of the phase adjusting layer 604 is different from a refractive index of a material of the index-mismatched layer 606. By way of example, a material of the phase adjusting layer 604 can have a refractive index n while a material of the index-mismatched layer 606 can have a refractive index n+Δn, where Δn is a difference between the refractive indices of the materials.

In some implementations, a second surface of the index-mismatched layer 606 can be configured to preserve a phase correction associated with the phase adjusting layer. For instance, a second surface of the index-mismatched layer 606 can be configured to preserve a phase correction associated with the phase adjusting layer by being substantially flat over an area associated with an optical aperture, i.e., an area intersecting an optical propagation path from the optical aperture and through a volume associated with a phase adjusting layer. By way of example, the index-mismatched layer 606 of FIG. 6A has a second surface 610 that is substantially flat.

In some implementations, the index-mismatched layer 606 can be configured to provide a small index contrast between the phase adjusting layer 604 and an additional index-mismatched layer, e.g., a so-called index-matching fluid, or polymer, or other material, to relax the resolution requirements for laser structuring.

Alternatively, a surface of an index-mismatched layer can be configured to provide a small index contrast by conforming to a surface of an optical element, i.e., an optical window, having a refractive index that is substantially identical to the refractive index of the index-mismatched layer. For instance, an index-mismatched layer can have an index of refraction that matches an index of refraction of an optical element within 10%. Such implementations can allow for the surface of the index-mismatched layer to preserve a phase correction associated with a phase adjusting layer.

Additionally, the index-mismatched layer may be designed to bond the optical chip to a window with anti-reflection (AR) or high-reflection (HR) coatings tailored to specific applications. These techniques can enable automatic fabrication of the phase adjusting layer for wavefront correction, and can have applications in areas such as light detection and ranging (LiDAR), augmented reality/virtual reality (AR/VR), telecommunications, imaging, medical devices, and astronomy, etc.

In other words, the index-mismatched layer 606 can also enable direct bonding of one or more optical windows to the structure, which can reduce optical losses and simplify packaging by providing a protective and planarizing cover for the polymers. In some examples, an optical window can also provide structural integrity to a device. FIG. 6B depicts a cross-sectional view of a portion 600B of an example device. In this example, the portion 600B comprises an optical window 612.

In some implementations, an anti-reflective (AR) or highly reflective (HR) coating can be formed on one or more surfaces of the optical window. FIG. 6C depicts a cross-sectional view of a portion 600C of an example device comprising a coating 614 formed on the optical window 612. As shown in FIG. 6C, the coating 614 is formed on a surface of the optical window 612 that is opposite to the surface of the optical window 612 that is adjacent to the second surface of the index-mismatched layer 606. Some anti-reflective coatings can comprise one or more layers of material formed on a surface of an optical component or other layers of material. In some examples, an anti-reflective coating can be configured to reduce reflections associated with optical waves at the interface of different materials, i.e., a layer of material and a layer of air.

In some implementations, when Δn=0.005, achieving a phase correction of 1/50π at a wavelength of 1500 nm can involve a laser-cut thickness of only 3 μm. This thickness is within the resolution capabilities of some laser structuring systems.

FIG. 6D depicts a cross-section of a portion 600D of a device comprising a similar configuration to the portion 600B. In this example, the phase adjusting layer comprises a plurality of sublayers 616A-616D, i.e., a sublayer 616A, a sublayer 616B, a sublayer 616C, and a sublayer 616D. Such sublayers can be formed by a process of additive manufacturing.

The shapes of the layers illustrated in FIGS. 5 and 6A-6D are merely an example for illustrative purposes, not necessarily the case for real world applications.

A direct-written phase adjusting layer can be used on a portion of an optical system that includes a surface emitting optical phased array (OPA). In some systems, the OPA consists of multiple antennas emitting in the same direction and form diffraction-limited beams in the far field for LiDAR or free space communication applications. The beams can be steered in one direction by adjusting the wavelength and in another perpendicular direction by adjusting the phase difference between antennas. For instance, beams can be steered along a y-axis associated with a device by adjusting wavelength and along an x-axis by adjusting phase. In some examples, fabrication processes can induce problems such as wafer bowing, dielectric layer thickness variation, photonic structure width variation, as well as other random errors. All these factors can lead to the divergence of the beams, if not corrected. In addition, a chip comprising both a transmitter and a receiver can have misalignment between the transmitter and the receiver due to nonuniform fabrication errors. The post-fabrication assembly process to integrate the chip into a system might also introduce more errors. With direct-written phase adjusting layer, all these errors can be reduced or eliminated, and can in some cases result in diffraction-limited beams. The angle of the beams can also be fixed through phase compensation in the direction needed, which can be used to align a transmitter and a receiver.

The techniques described herein can allow for partially or fully automated fabrication processes because fewer assembly steps are involved, and the laser writing process is contact-less. Rapid wavefront corrections can be enabled, which can increase the manufacturing speed for mass production and lowers the cost. Additionally, material cost can also be lowered since only one or few thin layers of polymers are used in the process.

Some systems can comprise a plurality of optical apertures, as depicted and described later. In some implementations, the previously-described technique can be applied to identify and correct a wavefront error associated with each optical aperture of the plurality of optical apertures.

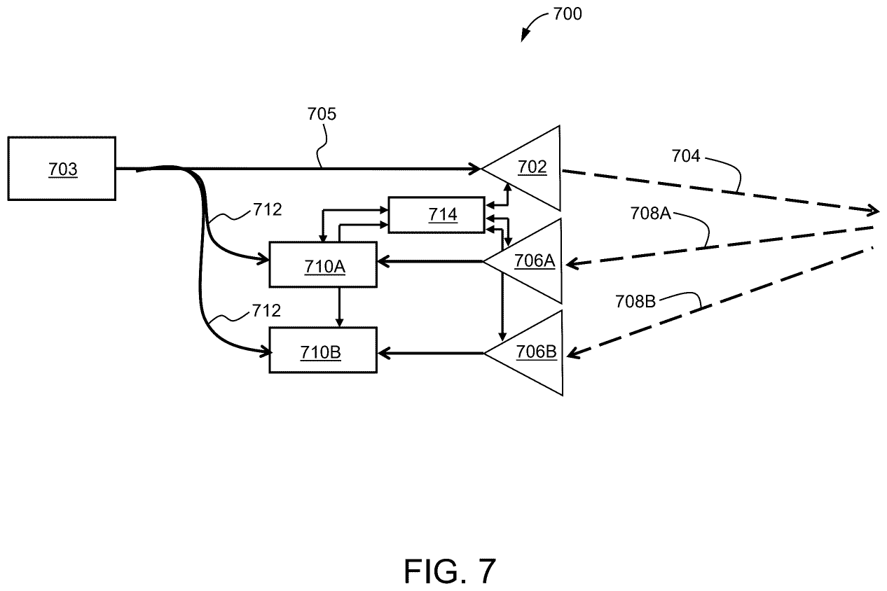

FIG. 7 shows an example of a system 700 in which the wavefront corrected optical system can be used. The system 700 is an example of a LiDAR system. The system 700 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, an antenna module can be configured to operate in both a transmitter (Tx) mode of operation and a receiver (Tx) mode of operation (i.e., in a monostatic arrangement) where the transmitting aperture and the receiving aperture are the same. In the example of FIG. 7, the system 700 includes a transmitter antenna module 702 that transmits an optical beam 704 at an angle that can be steered over a steering range, and a receiver antenna module 706A and a receiver antenna module 706B that can each be controlled to receive light incoming from a particular angle (i.e., a multi-static arrangement). For example, the receiver antenna module 706A can be configured to receiving incoming light 708A including a portion of the optical beam 704 backscattered from a target object or region, and the receiver antenna module 706B can be configured to receive incoming light 708B including a portion of the optical beam 704 backscattered from the target.

The system includes an optical source 703 that provides an optical wave 705 to the transmitter antenna module 702. In some implementations, the optical source 703 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 703 is a frequency tunable laser system in which the frequency of the light provided can be swept to perform frequency modulated continuous wave (FMCW) LiDAR measurements. A coherent receiver module 710A and a coherent receiver module 710B receiving collected light from the receiver antenna module 706A and the receiver antenna module 706B, respectively, are configured to coherently mix the collected light with light of a local oscillator 712, sometimes abbreviated LO, which can be derived from the optical source 703 or from a portion of the optical wave 705 provided to the transmitter antenna module 702. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 714 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 705 generated by the optical source 703. The control module 714 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

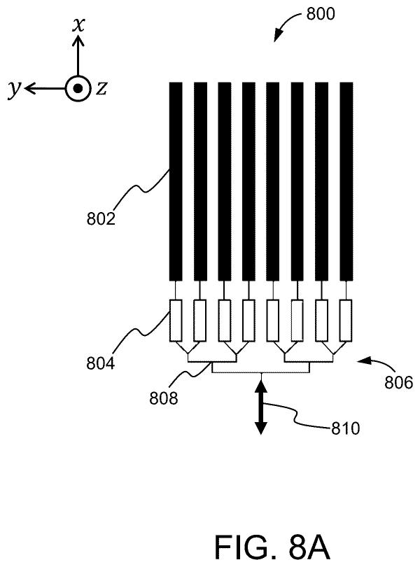

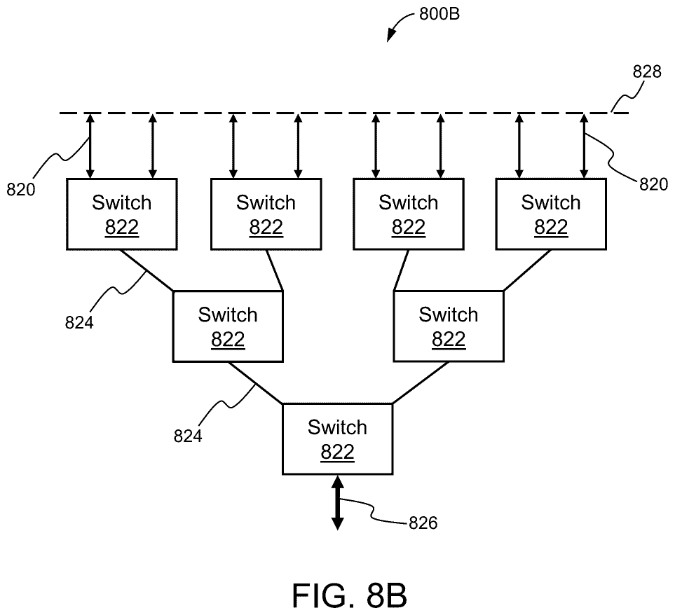

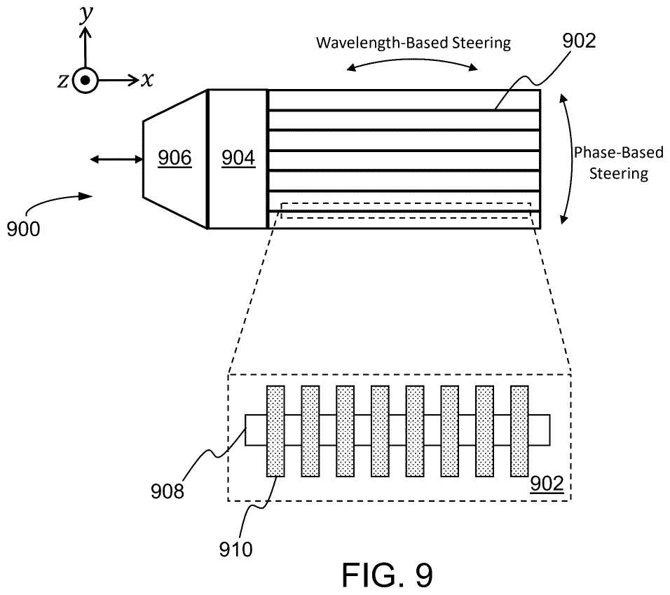

Any of a variety of techniques can be used to steer the transmission angle of the optical beam 704 provided by the transmitter antenna module 702 over a steering range, and to steer the reception angle of the receiver antenna module 706A and the receiver antenna module 706B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 8A shows an example OPA 800 that includes an array of optical antennas 802. Light can be emitted from (and/or received into) optical antennas 802 from different emission planes depending on the type of optical antennas being used. For a grating-antenna-based OPA, each optical antenna is configured as an optical grating, as described in more detail in FIG. 9, and power from individual optical waves is emitted gradually over the length of the optical gratings over an emission plane in the plane of the page in FIG. 8A (the x-y plane). Alternatively, for an end-fire-antenna-based OPA, each optical antenna is configured to emit light from the ends of the optical antennas at an emission plane that is perpendicular to the plane of the page in FIG. 8A (the y-z plane). In either case, the optical waves optically interfere with each other starting at the emission plane to form an optical phased array output beam when the OPA 800 is used as a transmitter. The direction of peak constructive interference depends on the relative phase shifts imposed on light entering the optical antennas.

The OPA 800 includes an array of optical phase shifters 804 that impose respective phase shifts on optical waves provided as phase shifted optical waves entering the optical antennas 802 when the OPA is used as a transmitter, or on optical waves that have been collected by optical antennas 802 when the OPA is used as a receiver. The optical phase shifters 804 can be, for example, electro-optic, thermal, liquid crystal, pn junction phase shifters. In some examples, each of the optical phase shifters 804 is controlled independently, while in other examples two or more of the optical phase shifters 804 may be jointly controlled. Δn optical coupler 806 is configured to couple an optical port 810 to the array of optical phase shifters 804. In this example, the optical coupler 806 is in the form of a power splitting network formed from interconnected power splitters of a plurality of power splitters 808. In this example, each power splitter of the plurality of power splitters 808 comprises a 1×2 power splitters (also referred to as 50/50 power splitter) and are interconnected by waveguides in a binary tree arrangement to achieve substantially equal power into each optical phase shifter of the optical phase shifters 804 from an input optical wave entering the optical port 810 when the OPA 800 is used as a transmitter (Tx operation), and to provide substantially equal path lengths between each optical phase shifter of the optical phase shifters 804 and the optical port 810. When the OPA 800 is used as a receiver (Rx operation), the light received by the optical antennas 802 and phase shifted by the optical phase shifters 804 is combined into an output optical wave at the optical port 810, which can then be further manipulated, transformed, or measured.

The OPA 800 is an example of a photonic integrated circuit comprising several optical components interconnected by structures configured to guide optical waves, sometimes referred to as optical waveguiding structures or optical waveguides. Some photonic integrated circuits can be formed on a silicon-on-insulator die. In some implementations, the OPA 800 can be formed in proximity to a surface of an optical aperture. Such implementations can allow for a plurality of optical waves to be emitted from the optical antennas 802. In other words, an optical aperture can comprise a surface from which a plurality of optical waves is emitted from respective optical antennas formed in proximity to the surface.

FIG. 8B shows an optical switched array 800B comprising an array of optical antennas 820 (e.g., waveguide facets in an end-fire configuration, optical gratings, plasmonic emitters, metal antennas, and mirror facets). The optical switched array 800B is arranged in a tree-like structure comprising a plurality of optical switches 822 optically interconnected via waveguides 824. In some examples, each optical switch of the plurality of optical switches 822 can be Mach-Zehnder interferometers or another kind of optical switch. Each optical switch of the plurality of optical switches 822 may be controlled in response to one or more applied voltages, allowing the plurality of optical switches 822 to direct light at a first switch port to a second switch port and a third switch port in a tunable ratio (e.g., 50/50, 33/66, 25/75). Accordingly, the plurality of optical switches 822 can be configured (e.g., by applied voltages) to open select optical pathways between an optical port 826 and the array of optical antennas 820. For example, by applying suitable (possibly time-varying) voltages, the optical switched array 800B can provide light (e.g., emitted from a laser) from the optical port 826 to one or more of the optical antennas 820. In another example, by applying suitable voltages, the optical switched array 800B can provide light received by one or more of the optical antennas 820 to the optical port 826. In an example that uses an end-fire configuration, light is transmitted from or received into the optical antennas 820 at facets distributed over an edge 828 along which the optical antennas 820 are arranged. In general, each optical switch of the plurality of optical switches 822 may have slightly different voltage requirements for power switching between their ports. Furthermore, one or more optical switches of the plurality of optical switches 822 may be electrically interconnected to allow for joint voltage control, possibly reducing the number of voltage sources used.

Referring again to FIG. 8B, each optical switch of the plurality of optical switches 822 are configured in a 1×2 arrangement, however, other arrangements (e.g., 1×3, 1×4, 2×2, or 2×3) and mixtures of arrangements may also be utilized. The one or more switch types in a optical switched array need not all be of the same type or of the same technology (e.g., thermo-optic or electro-optic switches). A portion or all of the optical switched array 800B may by formed as part of a PIC.

Some implementations can include a phase shifter (PS) module. FIG. 9 shows an example of a grating-antenna-based OPA 900 that is configured for phase-based steering about the x axis and wavelength-based steering about the y axis. For example, when configured for Tx operation, optical waves propagate along optical grating antennas 902 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a PS module 904 and the steering in the other angular direction being performed by wavelength of an optical wave distributing optical power via an optical coupler 906. The adjustment of the transmission angle for the Tx operation and collection angle for the Rx operation in the phase-controlled angular direction can be dynamically performed as the phases imposed by the phase shifters in the PS module 904 can be quickly tuned. Each optical grating antenna of the optical grating antennas 902 is formed from a waveguide 908 and grating elements 910 arranged periodically along the waveguide 908 with a particular pitch pl (e.g., a constant spacing between grating elements 910) to perturb the guided optical wave causing emission in the direction of the grating elements 910. The angle at which the light is emitted from each optical grating antenna of the optical grating antennas 902 depends on a relationship between the pitch pl and the wavelength, and thus can be steered by changing the wavelength.

The PS module 904 can also be configured to provide focusing. For example, the emitted light can have a nonlinear phase front imposed on it by the phase shifters in the PS module 904 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

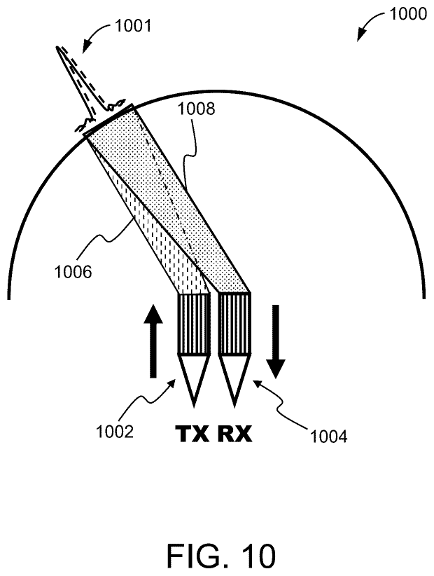

FIG. 10 shows an example LiDAR system 1000 producing radiation intensity patterns 1001 associated with a transmitter OPA 1002 and a receiver OPA 1004. In this example, main lobes associated with a transmitter radiation pattern 1006 and a receiver radiation pattern 1008 overlap. Such an arrangement of main lobe overlap can result, for example, from tuning phase shifters associated with transmitter and receiver optical antennas in the respective OPAs. Backscattered light from a target object situated near the main lobes is received by the receiver OPA 1004. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the 1=1500 to 1600 nm band or the 1=1270 to 1330 nm band, and the pitch p corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p≤4000 nm may be typical.

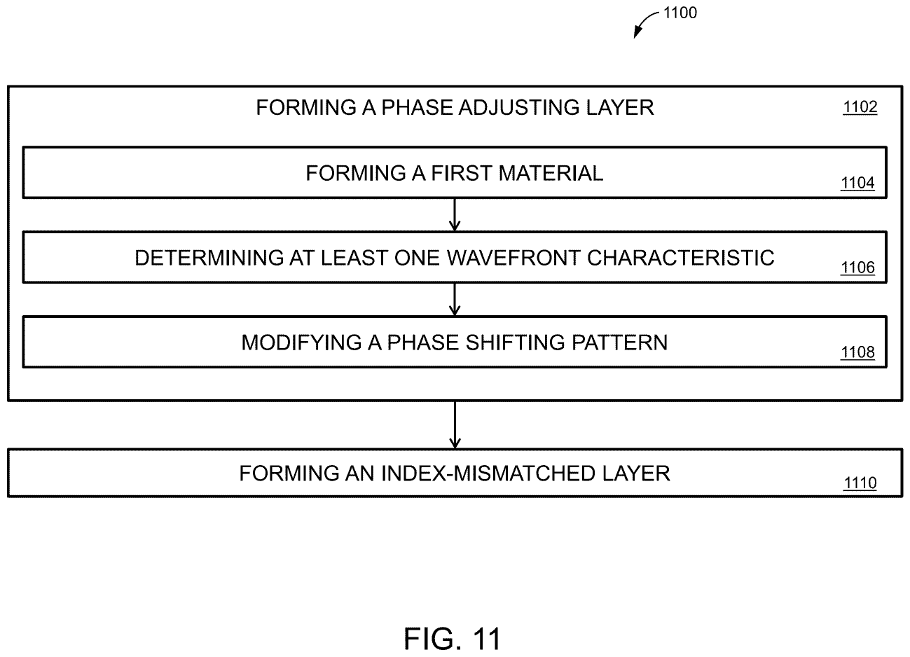

FIG. 11 depicts a flowchart of an example technique 1100. The technique 1100 can be used for forming a wavefront corrected optical system. The technique 1100 comprises forming 1102 a phase adjusting layer. In some implementations, the phase adjusting layer can be formed onto a portion of an optical aperture of an optical device.

The forming 1102 comprises forming 1104 a first material. In some implementations, the first material can be at least partially optically transparent and can be onto the portion of the optical aperture.

The forming 1102 further comprises determining 1106 at least one wavefront characteristic. In some implementations, the at least one wavefront characteristic can be associated with an optical wave emitted from the optical aperture.

The forming 1102 further comprises modifying 1108 a phase shifting pattern. In some implementations, the phase shifting pattern can be modified over a first volume of the first material based at least in part on the at least one wavefront characteristic.

The technique 1100 further comprises forming 1110 an index-mismatched layer. In some implementations, the index-mismatched layer can be formed onto at least a portion of the phase adjusting layer. In some implementations, a refractive index of the index-mismatched layer can be different from a refractive index of the first material, a first surface of the index-mismatched layer can conform to a surface of the phase adjusting layer, and a second surface of the index-mismatched layer can be configured to preserve a phase correction associated with the phase adjusting layer.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for forming a wavefront corrected optical system, the method comprising:
forming a phase adjusting layer onto a portion of an optical aperture of an optical device, the forming comprising:
forming a first material that is at least partially optically transparent onto the portion of the optical aperture,
determining at least one wavefront characteristic of an optical wave emitted from the optical aperture, and
modifying a phase shifting pattern over a first volume of the first material based at least in part on the at least one wavefront characteristic; and
forming an index-mismatched layer onto at least a portion of the phase adjusting layer, wherein:
a refractive index of the index-mismatched layer is different from a refractive index of the first material,
a first surface of the index-mismatched layer conforms to a surface of the phase adjusting layer, and
a second surface of the index-mismatched layer is configured to preserve a phase correction associated with the phase adjusting layer.

2. The method of claim 1, wherein the second surface of the index-mismatched layer is configured to preserve a phase correction associated with the phase adjusting layer by being substantially flat over a first area intersecting an optical propagation path from the optical aperture and through the first volume.

3. The method of claim 1, wherein the second surface of the index-mismatched layer is configured to preserve a phase correction associated with the phase adjusting layer by conforming to a surface of an optical element having a refractive index that is substantially identical to the refractive index of the index-mismatched layer.

4. The method of claim 1, wherein the modifying the phase shifting pattern over the first volume of the first material comprises removing at least a portion of the first material from at least a portion of the first volume.

5. The method of claim 4, wherein the removing is performed by hardening a first portion of the first material by absorption of optical power and removing a second portion of the first material that has not been hardened to form a pattern of different thicknesses of the first material over the first volume.

6. The method of claim 1, wherein the modifying the phase shifting pattern over the first volume of the first material comprises adding more of the first material over at least a portion of the first volume.

7. The method of claim 6, wherein the adding more of the first material comprises depositing multiple sublayers of the first material in different locations to form a pattern of different thicknesses of the first material over the first volume.

8. The method of claim 7, wherein the adding further comprises hardening portions of the multiple sublayers of the first material by absorption of optical power.

9. The method of claim 1, wherein the optical device comprises a photonic integrated circuit, a device comprising photonics metastructures, an optoelectronic device, or a surface emitting laser.

10. The method of claim 9, wherein the optical aperture comprises a surface from which a plurality of optical waves is emitted from respective optical antennas formed in proximity to the surface.

11. The method of claim 9, wherein the phase adjusting layer is formed after assembling the photonic integrated circuit onto a portion of an optical system.

12. The method of claim 9, wherein the photonic integrated circuit is formed on a silicon-on-insulator die.

13. The method of claim 1, wherein the forming further comprises, for each iteration of a plurality of iterations,
determining at least one wavefront characteristic of an optical wave emitted from the optical aperture, and
modifying a phase shifting pattern over a portion of the first volume of the first material based at least in part on the at least one wavefront characteristic.

14. An apparatus comprising:
an optical device comprising an optical aperture configured to transmit and/or receive one or more optical waves;
a phase adjusting layer formed on a portion of the optical aperture, wherein the phase adjusting layer:
is formed from a first material that is at least partially optically transparent, and
provides a phase shifting pattern over a first volume of the first material based at least in part on at least one wavefront characteristic of an optical wave emitted from the optical aperture determined before the phase adjusting layer was modified to provide the phase shifting pattern; and
an index-mismatched layer formed on at least a portion of the phase adjusting layer, wherein:
a refractive index of the index-mismatched layer is different from a refractive index of the first material,
a first surface of the index-mismatched layer conforms to a surface of the phase adjusting layer, and
a second surface of the index-mismatched layer is configured to preserve a phase correction associated with the phase adjusting layer.

15. The apparatus of claim 14, wherein the second surface of the index-mismatched layer is configured to preserve a phase correction associated with the phase adjusting layer by being substantially flat over a first area intersecting an optical propagation path from the optical aperture and through the first volume.

16. The apparatus of claim 15, wherein the second surface of the index-mismatched layer is tilted such that the second surface is not parallel to a surface of the optical aperture.

17. The apparatus of claim 14, wherein the second surface of the index-mismatched layer is configured to preserve a phase correction associated with the phase adjusting layer by conforming to a first surface of an optical element having a refractive index that is substantially identical to the refractive index of the index-mismatched layer.

18. The apparatus of claim 17, wherein the first surface of the optical element is bonded to the second surface of the index-mismatched layer.

19. The apparatus of claim 17, wherein a second surface of the optical element has a coating comprising one or more layers formed on the second surface of the optical element, where the coating is configured to reduce reflections of the second surface of the optical element.

20. The apparatus of claim 14, wherein the optical device comprises a photonic integrated circuit, a device comprising photonics metastructures, an optoelectronic device, or a surface emitting laser.
